(19) United States
(12) Patent Application Publication
(10) Pub. No.: US 2002/0029216 A1
(43) Pub. Date: Mar. 7, 2002

(54) Device and method for supplying the information of DVDs

(76) Inventor: Honder Tzou, Taipei Hsien (TW)

Correspondence Address: BIRCH STEWART KOLASCH & BIRCH, PO BOX 747, FALLS CHURCH, VA, 22040-0747, US

(21) Appl. No.: 09/760,842

(22) Filed: Jan. 17, 2001

(30) Foreign Application Priority Data
Sep. 2, 2000 (TW) 89117962

(51) Int. Cl. G06F 7/00

(52) U.S. Cl. 707/100

(57) ABSTRACT

A method for supplying a specific information related to a data unit, which comprises the steps as blew. The DVD player gets a data unit identifier of the data unit from the client end and transfers the data unit identifier and a user identifier from the client end to a server through a network. Then the server sends a service selection according to the user identifier to the client end. The client end selects the service selection and sends a selected result to the server. Eventually, the server sends the specific information responding to the data unit identifier and the selected result to the client end.

### BACKGROUND OF THE INVENTION

1. Field of the Invention

The present invention relates in general to a device and method for supplying the information of DVDs. In particular, the present invention relates to a device and method for supplying the information of the movies in the DVD disc through a network.

2. Description of the Related Art

The information of DVDs refers to, for example, database of type of the DVD, category of the movies, summary of the plot, introduction of the actors/actress, the film review, discussion groups of general users etc.

The Internet allows a vast number of computers and computer networks that are connected through communication links to exchange information easily. A number of services are active for this purpose. For example, World Wide Web (WWW) makes the sending of multimedia information via Internet possible. The WWW service allows a server to send Web page (HTML, XML or others ) document to a remote client computer system. The remote client computer system can then display the Web pages. The mechanism of the WWW service can be depicted as follow. Each client system and web page is specified with a URL (Universal Resource Locator).

The client needs to know the URL of a specific web page in a request, so the WWW service can direct this request to the referred server system supporting that web page. Upon receiving the request, the server system sends that Web page to the client system. When the client system receives the Web page, the application to interpret and display the Web page is executed. The application is a software with special-purpose and is usually called “browser”.

In a Web page, users can also effects request to receive new Web page via Internet. HTTP is currently defined for this purpose. The HTTP (Hyper Text Transfer Protocol) receives a URL either specified by the user or a link on the current Web page. This indicates to the browser that a new Web page is expected. The format of transmitted Web page is generally defined by the HTML (Hyper Text Markup Language). User can apply a set of tags defined by the HTML to his Web page. The browser will interpret the received Web page according to the definition of HTML as to how the Web page is displayed.

The World Wide Web is a fascinating tool for installing a database as information center, with which people can connect to other people and facility of shared interest and value. Web server can be developed through which people of shared interest can exchange information. The links designed to embed in the Web page can connect to more Web sites and bring more relevant information. The usual activities among people with shared interest and value are, to name a few, a discussion group, a chatting session, a lecture by an expert or a visit to an exhibition. With the aids of WWW, a virtual community on the Internet can provide electronic version of the above services. A server system can connect to potential users who are interested in joining the virtual community. A server system can also connect to potential Web sites, which may contain stuff interesting to the members in the virtual community. A user, who is a potential user of the database service, may browse through the community services using a browser and register as a member of the community. When the user sends out the registering request, the server computer system prompts the user for information to complete the process and an identity for the user in the virtual community is thus created. The user-specific information may include the user's name, the user's age, the user's preference, etc. The server computer system then typically confirms the acceptance by sending a confirmation Web page to the client computer system and schedules to validate the membership.

Since the registering information contains personal information (e.g. age, preference), both sides want to keep the information hidden. Privacy is a concern because information transmitted over the Internet may pass through various intermediate computer systems on its way to its final destination. The information is usually encrypted during the sending and receiving session to ensure the privacy of such information. However, there is always possibility that the third party may intercept and decrypt the information successfully. Therefore, it would be desirable to protect the private information transmitted when the user register as a member.

In addition to the privacy problem, the overhead of registering to join the community reduces the number of users to join the community. For example, the user decides to join the community and issues the request. The user is then presented with a Web page that prompts the user for personal information to complete the registration. The information is then validated by the server system and the registration is complete. Such a process can be cumbersome. If the user is registering for the first time, then the process of confirming the various steps of the registration process and waiting for, viewing, and updating the user-specific preference information can be an overhead.

With the common use of the WWW, there are various information on the network. However, the user has to spend a lot of time searching the needed information. In the conventional way of using the search engine, the user has to key in the keywords and browse through the information obtained from the search engine one by one. Since the search engine is usually designed for a general purpose, the search result may not match the needs of the users. Moreover, most of the virtual groups awaits the users to join passively. In such circumstances it is very hard for the virtual groups to attract the attention of the users to join actively, and for the users to search the virtual groups that interest them. As a result, it is very important to provide the virtual groups connection actively and enable the users to search the interested virtual group without complicated searching steps.

### SUMMARY OF THE INVENTION

The object of the present invention is providing a device and method for supplying the information of DVDs through a network. The users of the DVD players in the client end can use the information of a specific DVD disc in the data-base of a server without complicated operations. The client system is provided with an identifier that identifies the DVD player user. The client system displays information that identifies services in the database and displays an indication of an action that a DVD player user is to perform to validate the access to DVD information services. In response to the indicated action being performed, the client system sends to the server system the provided user identifier, DVD identifier and service identifiers and a request to validate the access. The server system uses the user identifier, DVD identifier and service identifier to retrieve additional information needed to validate the access and enable the selected DVD information services. The server system stores the additional information for DVD player users using various computer systems so that the server system can record user's activity in user's personal journey. The server system stores the additional information in associated with the user identifier and retrieve the additional information next time the identifier to the client system is validated. When requested by the client system, the server system combines the additional information stored in association with the identifier included in the request to effect the validating of the access to DVD information services.

To achieve the above-mentioned object, the present invention provides a device for supplying a specific information relating to a data unit by a network. The apparaturs comprises a server and a client end. The server comprises a database, which is used for storing the specific information. The server outputs a service selection responding to a user identifier and a service identifier, then outputs the specific information according to a data unit identifier and a selected result. The client end outputs the user identifier, the service identifier, the data unit identifier, and the selected result according to the selected service to the server, then receives the specific information from the server through the network.

The present invention further provides a method for supplying a specific information related to a data unit, comprising steps as below. The DVD player gets a data unit identifier of the data unit from the client end and transfers the data unit identifier and a user identifier from the client end to a server through a network. Then the server sends a service selection according to the user identifier to the client end. The client end selects the service selection and sends a selected result to the server. Eventually, the server sends the specific information responding to the data unit identifier and the selected result to the client end.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1A˜1C shows the user interface of the embodiment according to the present invention.

FIG. 2 shows a block diagram of the embodiment according to the present invention.

FIG. 3A˜3C show flow charts of the embodiment according to the present invention.

### DETAILED DESCRIPTION OF THE PREFERRED EMBODIMENT

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

The present invention provides a method and device for accessing DVD information services in a client/server environment. The target is for DVD player users connected to Internet. The method and device of the present invention reduces the overhead needed to register as a member in the database and reduce the amount of personal information that is transmitted between a client system and a server system. The server system assigns a unique client identifier to each client system. The server also stores viewer-specific information for various potential DVD player users. The viewer-specific information may have been collected from previous activity in the DVD information service. The server system can map additional identifier to a DVD player user that may use that client system to watch DVD title. When a DVD viewer inserts the DVD disc to the DVD player, client system automatically calculates the DVD identifier and sends request to server system that supports the DVD information services. This issuing of request from the client side is executed automatically right after the instant user inserting the DVD disc to DVD ROM drive and DVD identifier is calculated. The transmitted information is about the DVD viewing status including the DVD identifier or URL of the client system. The personal information is almost none to initialize the validation process. The server system then determines if the received DVD information already maps to an identity in the database. If so mapped, the server system determines which DVD information service is compatible with the viewer's preference and sends (via Web page) the service data accompanied with a validation button to the client side. The server system then completes the validation by enabling the services selected in the database. Moreover, since the client identifier identifying DVD player user's DVD viewing history is stored at the server system, there is no needs to investigate on the user's preference in each usage.

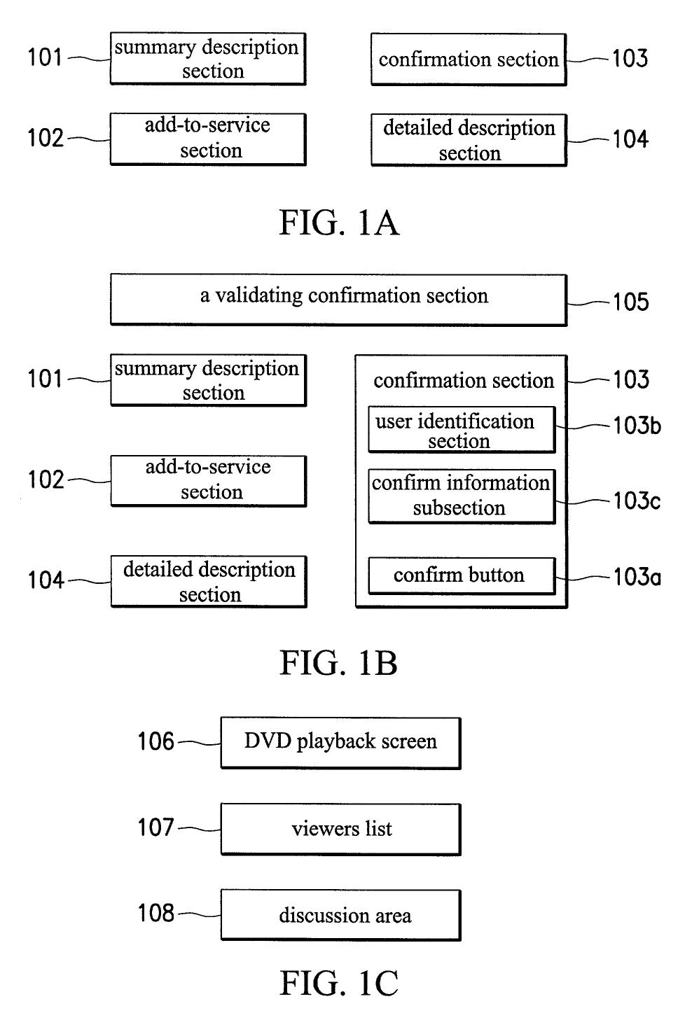

FIGS. 1A-1C illustrate the user interface in the embodiment of the present invention. FIG. 1A illustrates the display of a chart describing service that may be selected. The display was sent from the server system to the client system when the insertion of DVD to the DVD drive is recognized at the client. This user interface in the embodiment contains a summary description section 101, an add-to-service section 102, a confirmation section 103, and a detailed description section 104. One skilled in the art would appreciate that these various sections can be omitted or rearranged or adapted in various ways. The summary description and the detailed description sections provide information that identifies and describes the service(s) that may be selected. The add-to-service section 102 provides the capability to add the selected service to the list. The server system adds the summary description 101, the detailed description 104, and the add-to-service sections 102 to each Web page for a service that may be selected. The server system, however, only adds the confirmation section 103 when the confirmation is enabled for that DVD player user at the client system. Once the user enables the confirming operation, such as clicks the mouse button, the identity is validated unless the user then takes some action to change the status. The confirmation section 103 contains a confirm button 103a, user identification section 103b, and confirm information subsection 103c. The user information subsection displays enough information so that the user can verify that the server system correctly recognizes the DVD player user. To protect the privacy, the server system sends only enough information so that the user is confident that the server system correctly identified the user but yet not enough information to be useful to an unscrupulous interceptor. The additional information subsections allow the user to obtain various settings or obtain more information related to confirmation. If the user wants to verify the user identifier, the user can select the “check the user identifier in the DVD-DB” label. In response to this selection, the server system may require the user to perform a “login” so that the user identifier in the DVD database can be verified before it is validated or modified. The server system then sends a Web page to the client system for display and possible modification of the identity. In this way, the transmitting of the private preference can be avoided unless requested by the verified user. When the user selects the confirm button, the client system sends a message to the server system requesting that the selected services be enabled. After the server system processes the message, the server system provides to the client system a new Web page that confirms the receipt of the confirming.

FIG. 1B illustrates the display of a confirming Web page. The confirming Web page contains essentially the same information as the Web page as the Web page describing the service (i.e. FIG. 1A) except that a validating confirmation section 105 is displayed at the top of the Web page. The validating confirmation section 105 confirms that the user has been admitted and the selected service is active for the user now. Alternatively, the confirming Web page can be identical to the Web page describing the service (i.e. FIG. 1A), except that the confirm button is replaced with a message confirming the validation.

If the confirming of the user not currently enabled for the client system but could be enabled, then the server system can generate a Web page like FIG. 1A, except that the confirm button 103a is replaced by a enable button. Such a replacement button could contain text instructing the user to click on the button to enable a validation. When the user clicks on that button, the server system would send the Web page of FIG. 1A to be displayed. The operation of confirming can be enabled whenever the server system has stored sufficient user-specific validation information for that client system to complete the operation of confirming. If the server system does not have sufficient information, then when the user selects the confirm button 103a, the server system can provide a Web page to collect the additional information that is needed. The server system may require the user to “login” so that the identity of the user can be created before the confirming operation. FIG. 1C shows the DVD information service is enabled. The DVD playback screen is on 106. The DVD player user can watch the DVD title with a group of people on the Internet, whose names are in the viewers list 107. It shows that other people are watching the same DVD title with him and they also select the same DVD-DB service. Because of the selected service of DVD information, the user can send comments to the discussion area 108.

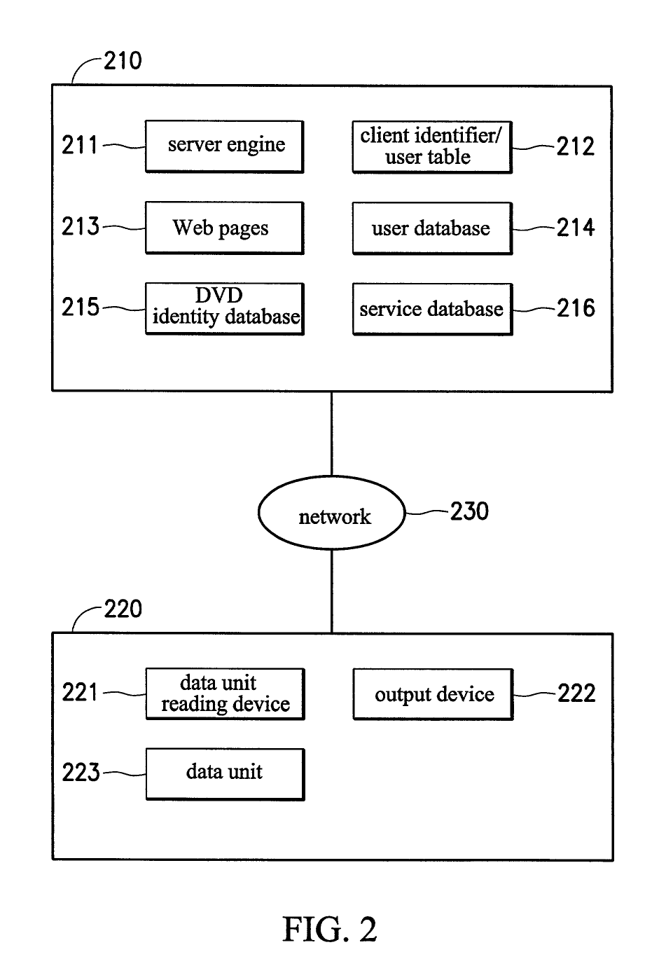

Now will describe the strcture in the embodiment of the present invention. Referring to FIG. 2, which shows a block diagram of the embodiment according to the present invention.

The apparaturs according to the embodiment comprises a server 210 and a client end 220. The server 210 comprises a database 214, which is used for storing the specific information. The server 210 outputs a service selection responding to a user identifier and a service identifier, then outputs the specific information according to a data unit identifier and a selected result. The client end 220 sends the user identifier, the service identifier, the data unit identifier, and the selected result according to the selected service to the server 210, then receives the specific information from the server 210 through the network 230.

The client end 220 comprises a data unit reading device 221 and an output device 222, the data unit reading device 221 reads the data unit 223 to get an output data and the data unit identifier, then outputs the data unit identifier to the server 210 through the network 230, and the output device 222 is used for output the output data and the specific information to the server 210. In this embodiment, the data unit reading device 221 can be a DVD drive, the output device 222 can be a monitor, and the data unit 223 is a DVD disc.

The server system 210 includes a server engine 211, a client identifier/user table 212, various Web pages 213, a user database 214, an identity database 215, and a service database 216. The server engine receives HTTP requests to access Web pages identified by URLs and provides the Web pages to the various client systems. Such an HTTP request may indicate that the user has performed the confirming operation. The user database contains user information for various user or potential users. The user information includes DVD player-specific identity information such as the serial number of the DVD player, DVD viewing statistic information, service selection information and identity list information. The DVD title database 215 contains an entry for each DVD title that has been in the market. The service database 216 contains the descriptions for the various services that may be selected. The client identifier/user table 212 contains a mapping from each client identifier, which is globally unique identifier that uniquely identifies a client system, to the user last associated with that client system. The client system 220 contains a browser and its assigned client identifier. The client identifier is stored in a file, referred as a “cookie”. In one example, the server system 211 assigns and sends the client identifier to the client system 220 once when the client system first interacts with the server system. From then on, the client system includes its client identifier with all messages sent to the server system so that the server system can identify the source of the message. The server 211 and client systems 220 interact by exchanging information via communication link 230, which may include transmission over the Internet.

One skilled in the art would appreciate that the arrangement of the embodiment can be used in various environments other than the Internet. For example, applying to an electronic mail environment in which a service is described in an electronic mail message along with an indication of the confirming operation that is to be performed to effect the ordering of the item. Also, various communication channels may be used such as local area network, wide area network, or point-to-point dial up connection. A client system may comprise any combination of hardware or software that can interact with the server system. These systems may include television-based systems or various other consumer products through which identity cab be validated.

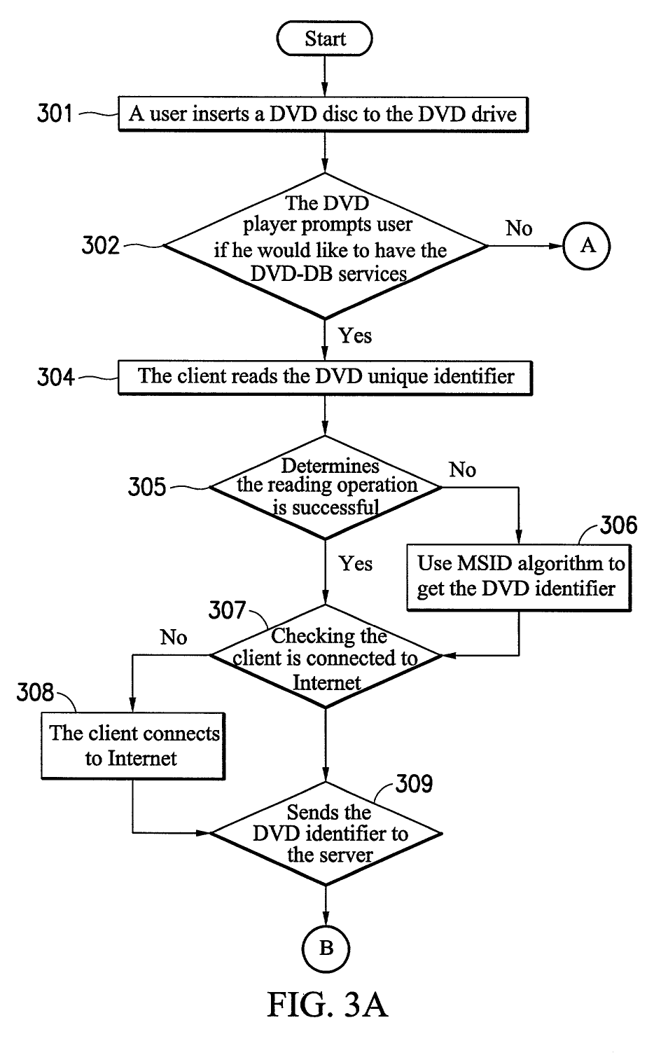

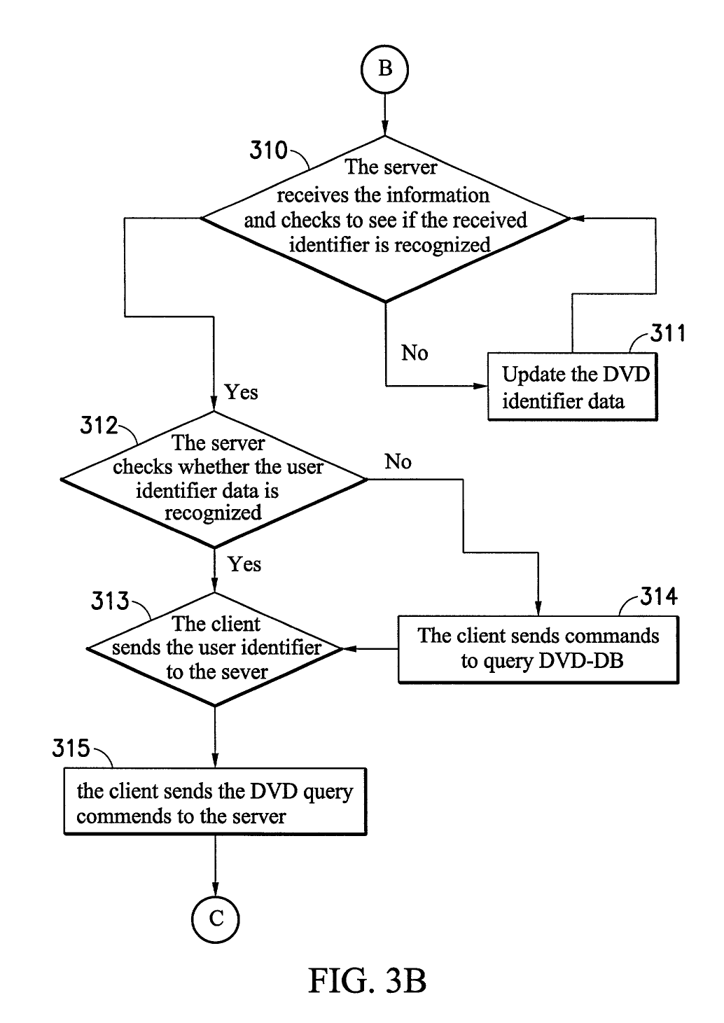

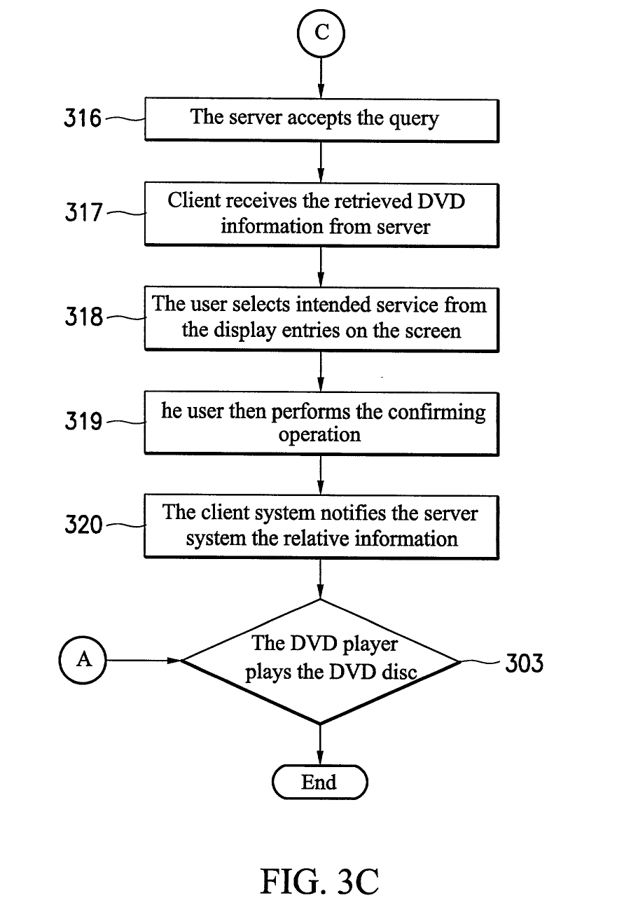

This paragraph describes the operations of the embodiment of the present invention. Referring to the FIG. 3A˜3C, the FIG. 3A˜3C show the operations of the embodiment according to the present invention. When a user inserts a DVD disc to the DVD drive 301, the DVD player prompts user if he would like to have the DVD information services 302. If the user needs only watch the DVD, he may choose to continue the DVD entertainment without the initialization for validating DVD information service 303. But, if the user intends to acquire DVD information service, the initialization process will go on. The client then reads the DVD identifier 304. Then determines whether the reading operation is successful 305, if not, MSID algorithm is used to get the DVD identifier when the previous calculation fails 306. Once the DVD identifier is obtained, the user is reminded to check if the client is connected to Internet 307. If the client doesn't connect to Internet, the client has to connect to Internet 308. Then the functioning communication network will direct the DVD identifier in client to server 309.

Referring to FIG. 3B, the server receives the information and checks to see if the received identifier is recognized 310. If not, DVD-DB supported in the server will invoke its engine to update its stored data 311. If yes, the server checks whether the user identifier data is recognized 312. If the user identifier data is not recognized, the client sends commands to query DVD 314 about the user identifier. If the user identifier data is recognized, the client sends the user identifier to the sever 313. The user identifier data is the information of the user identifier. Then the client sends the DVD query commands to the server 315.

The server accepts the query 316 and retrieves the database for the DVD information corresponding to the DVD title whose DVD identifier identifies it exclusively. The information services vary on each DVD title. Client receives the retrieved DVD information from server and associates the DVD information received from the server and local service appearance template to display the available services 317. Once the user decides to subscribe to the DVD information services, he can select intended service from the display entries on the screen 318. The user then performs the confirming operation 319. The client system notifies the server system the following information: service identifier, user identifier and DVD identifier 320. The server system then combines the user-specific identity information for the user associated with the client system with the service selection information to complete the validation. Finally, carry out the display of the DVD 303.

Although the present invention has been described in terms of various embodiments, it is not intended that the invention be limited to these embodiments. Modification within the spirit of the invention will be apparent to those skilled in the art.

For example, the server system can map a client identifier to multiple users who have recently used the client system. The server system can then allow the user to identify him by selecting one of the mappings based preferably on a display of partial user-specific identity information. Finally, a unique user identifier that is provided by the user when the user initiates access to the server system and sent to the server system with each message can alternatively identify the user. This customer identifier could be also stored persistently on the client system so that the server does not need to search for user identifier in the database each time access is initiated.

What is claimed is:

1. A device for supplying a specific information relating to a data unit by a network, comprising:
a server comprising a database, which is used for storing the specific information, the server provides a service selection responding to a user identifier and a service identifier, then outputs the specific information according to a data unit identifier and a selected result; and
a client end for sending the user identifier, the service identifier, the data unit identifier, and the selected result according to the selected service to the server, then receiving the specific information from the server through the network.

2. The device as claimed in claim 1, wherein the client end has a data unit reading device and an output device, the data unit reading device reads the data unit to get an output data and the data unit identifier, then outputs the data unit identifier to the server through the network, and the output device is used for output the output data and the specific information.

3. The device as claimed in claim 2, wherein the specific information is outputted by a browser.

4. The device as claimed in claim 3, wherein the server further comprising:
a data storing unit for storing the user identifier; and
a information searching unit for searching the information responding the user identifier in the database, and supplying the specific information to the client end through the network.

5. The device as claimed in claim 4, wherein the data unit is a DVD disc.

6. The device as claimed in claim 5, wherein the data unit reading device is a DVD player.

7. The device as claimed in claim 6, wherein the output device is a monitor.

8. The device as claimed in claim 7, wherein the specific information is the specification of the DVD video.

9. The device as claimed in claim 8, wherein the specific information describes the types of the movie.

10. The device as claimed in claim 9, wherein the specific information describes the summary of the movie.

11. The device as claimed in claim 10, wherein the specific information describes the actors of the movie.

12. The device as claimed in claim 11, wherein the specific information describes the film views of the movie.

13. The device as claimed in claim 12, wherein the network is Internet.

14. A method for supplying a specific information related to a data unit, comprising the following steps:
getting a data unit identifier of the data unit from the client end;
transferring the data unit identifier and a user identifier from the client end to a server through a network;
sending a service selection according to the user identifier by the server to the client end;
sending a selected result by the client end, wherein the selected result is generated by selecting the service selection with the client end; and
sending the specific information responding to the data unit identifier and the selected result by the server to the client end.

15. The method as claimed in claim 14, wherein the client end further provides a service identifier responding to the user identifier to the server, then the server provides the specific information responding to the service identifier to the client end.

16. The method as claimed in claim 15, wherein the server provides the selected result of the service selection setting by the client end in advance responding to the service identifier to the client end.

17. The method as claimed in claim 16, wherein the data unit is a DVD disc.

18. The method as claimed in claim 17, wherein the specific information is the specifications data of the DVD-Video of the DVD disc.

19. The method as claimed in claim 18, wherein the specific information describes the types of the movie.

20. The method as claimed in claim 19, wherein the specific information describes the summary of the movie.

21. The method as claimed in claim 20, wherein the specific information describes the actors of the movie.

22. The method as claimed in claim 21, wherein the specific information describes the film views of the movie.

23. The method as claimed in claim22, wherein the network is Internet.
